(19) United States
(12) Patent Application Publication
(10) Pub. No.: US 2025/0246657 A1
(43) Pub. Date: Jul. 31, 2025

(54) FUEL CELL ACTIVATION APPARATUS

(71) Applicant: HONDA MOTOR CO., LTD., Tokyo (JP)

(72) Inventors: Ryo MOCHIZUKI, Saitama (JP); Ken TAGAWA, Saitama (JP); Ryo KOBAYASHI, Saitama (JP)

(21) Appl. No.: 19/033,488

(22) Filed: Jan. 22, 2025

(30) Foreign Application Priority Data
Jan. 26, 2024 (JP) 2024-010273

(51) Int. Cl. H01M 8/04858; H01M 4/92; H01M 8/04082; H01M 8/1004; H01M 8/1007

(52) U.S. Cl. CPC H01M 8/04873; H01M 4/92; H01M 8/04201; H01M 8/1004; H01M 8/1007

(57) ABSTRACT

A fuel cell activation apparatus activates fuel cells. The fuel cells include, in order from one side, an anode layer, an electrolyte membrane, and a cathode layer. The anode layer and the cathode layer contain platinum as a catalyst. The fuel cell activation apparatus includes an anode-side gas supply device, a cathode-side gas supply device, and a potential scanning circuit. The fuel cell activation apparatus activates the fuel cells by supplying a fuel gas to the anode layer by the anode-side gas supply device, supplying a low oxygen gas to the cathode layer by the cathode-side gas supply device, and controlling a cathode potential by the potential scanning circuit.

This application is based on and claims the benefit of priority from Japanese Patent Application No. 2024-010273, filed on 26 Jan. 2024, the content of which is incorporated herein by reference.

### BACKGROUND OF THE INVENTION

### Field of the Invention

The present invention relates to an apparatus for activating a fuel cell.

### Related Art

Some fuel cells include an anode layer, an electrolyte membrane, and a cathode layer in order from one side. The anode layer and the cathode layer contain platinum as a catalyst. During power generation, a fuel gas as a gas containing hydrogen is humidified and supplied to the anode layer. On the other hand, an oxidizing gas as a gas containing oxygen is humidified and supplied to the cathode layer.
Patent Document 1: Japanese Unexamined Patent Application, Publication No. 2023-161181

### SUMMARY OF THE INVENTION

In such a fuel cell, the performance immediately after production is often insufficient. The reasons for this include insufficient humidification of ionomers in the anode-side catalyst layer, the electrolyte membrane, or the cathode-side catalyst layer, and deposits adhering to the platinum. Therefore, it is necessary to activate each fuel cell before shipment of a fuel cell stack. As methods for activation, there are a power generation method and a non-power generation method described below.

In the power generation method, the fuel gas is actually humidified and supplied to the anode layer, the oxidizing gas is actually humidified and supplied to the cathode layer, and the anode layer and the cathode layer are electrically connected to each other via a load, whereby power generation is actually performed. By the ion flow and the generated water accompanying this power generation, the deposits adhering to the platinum is washed away to activate the fuel cell. Further, at this time, moisture in the fuel gas and the oxidizing gas is supplied to the anode layer, the electrolyte membrane, and the cathode layer, and the fuel cell is humidified, whereby the fuel cell is also activated. However, such a power generation method has a high output because power generation is actually performed. Therefore, the cost of the fuel cell activation apparatus main body and operation is high.

On the other hand, in the non-power generation method, the fuel gas is actually humidified and supplied to the anode layer, while an inert gas containing no oxygen is humidified and supplied to the cathode layer, and the potential is controlled using an external device. That is, when the fuel gas is supplied to the anode layer and the cathode potential is controlled by the potential scanning circuit, a proton pump is generated as a phenomenon in which hydrogen ions dissociated from hydrogen molecules in the fuel gas pass through the electrolyte membrane and migrate to the cathode layer. The hydrogen ions migrated to the cathode layer by the proton pump combine with electrons migrated to the cathode layer through the load circuit to form hydrogen molecules. A proton pump is performed by the above-described series of flows.

According to this non-power generation method, since the oxidizing gas is not supplied to the cathode layer, the output of the fuel cell can be suppressed as compared with the power generation method. On the other hand, since the fuel gas is supplied to the anode layer, the proton pump can be generated. Therefore, according to the non-power generation method, while the output of the fuel cell is suppressed, moisture migrates along with the migration of hydrogen ions by the proton pump, and the fuel cell is humidified. Therefore, the fuel cell can be activated at a lower output than the power generation method. However, the activation effect of the fuel cell is lower than that of the power generation method.

The present invention has been made in view of the above circumstances, and it is an object of the present invention to achieve a higher activation effect than a conventional non-power generation method, but at a lower cost than a conventional power generation method.

The present inventors have found that the above object can be achieved by supplying a low oxygen gas to the cathode layer during proton pump, thereby arriving at the present invention. The present invention provides the fuel cell activating apparatus according to the following first aspect and second aspect.

According to a first aspect, a fuel cell activation apparatus is provided that activates a fuel cell. The fuel cell includes, in order from one side, an anode layer, an electrolyte membrane, and a cathode layer, the anode layer. The cathode layer includes platinum as a catalyst. The fuel cell activation apparatus includes: an anode-side gas supply device that is configured to supply a fuel gas as a gas including hydrogen to the anode layer; a cathode-side gas supply device that is configured to supply a low oxygen gas as a gas having an oxygen concentration lower than that of air to the cathode layer; and a potential scanning circuit that is configured to control a potential of the fuel cell. The anode-side gas supply device supplies the fuel gas to the anode layer, the cathode-side gas supply device supplies the low oxygen gas to the cathode layer, and the potential scanning circuit controls the potential of the cathode layer, such that the fuel cell is activated.

According to this configuration, the proton pump is generated by supplying the fuel gas to the anode layer and controlling the potential of the cathode layer by the potential scanning circuit. The hydrogen ions migrated to the cathode layer by the proton pump combine with oxygen in the low oxygen gas on the platinum catalyst surface to generate water. The water cleans the adhering matter adhering to the platinum in the cathode layer. In addition, the fuel cell is humidified by the generated water. This makes it possible to achieve a higher activation effect than a conventional proton pump supplying inert gas to the cathode layer.

Further, at this time, since the low oxygen gas is supplied to the cathode layer, the cathode stoichiometric ratio becomes lower than that in the case where air is supplied. Here, the cathode stoichiometric ratio refers to an optimum ratio of the amount of gas supplied to the anode layer to the amount of gas supplied to the cathode layer. By lowering the cathode stoichiometric ratio in this way, it is possible to suppress the supply amount of the fuel gas and suppress the output of the fuel cell. With such a configuration, it is possible to reduce the fuel cell active apparatus main body in size, and it is possible to reduce the cost as compared with the conventional power generation method.

As described above, according to the present configuration, by supplying the low oxygen gas to the cathode layer at the time of proton pump, it is possible to achieve the activation effect higher than that of the conventional non-power generation method at a cost lower than that of the conventional power generation method.

According to the second aspect, in the fuel cell activation apparatus as described in the first aspect above, the cathode-side gas supply device supplies air and nitrogen to the cathode layer to supply the low oxygen gas to the cathode layer.

According to this configuration, it is possible to supply low oxygen gas simply and inexpensively to the cathode layer.

As described above, according to the first aspect above, it is possible to realize the obtaining a higher activation effect than the conventional non-power generation method at a lower cost than the conventional power generation method. Further, according to the configuration as described in the second aspect citing the first aspect, it is possible to obtain the additional advantageous effects.

### BRIEF DESCRIPTION OF THE DRAWINGS

FIG. 1 is a schematic view showing a fuel cell activation apparatus according to a first embodiment;

FIG. 2 is a schematic view showing a state during activation of a fuel cell by the fuel cell activation apparatus;

FIG. 3 is a schematic view showing a state during activation of a fuel cell according to a comparative embodiment; and

FIG. 4 is a schematic view showing a state during power generation by a fuel cell.

### DETAILED DESCRIPTION OF THE INVENTION

Hereinafter, embodiments of the present invention will be described with reference to the drawings. However, the present invention is in no way limited to the following embodiments, and can be appropriately modified and implemented within a range not departing from the gist of the present invention.

### First Embodiment

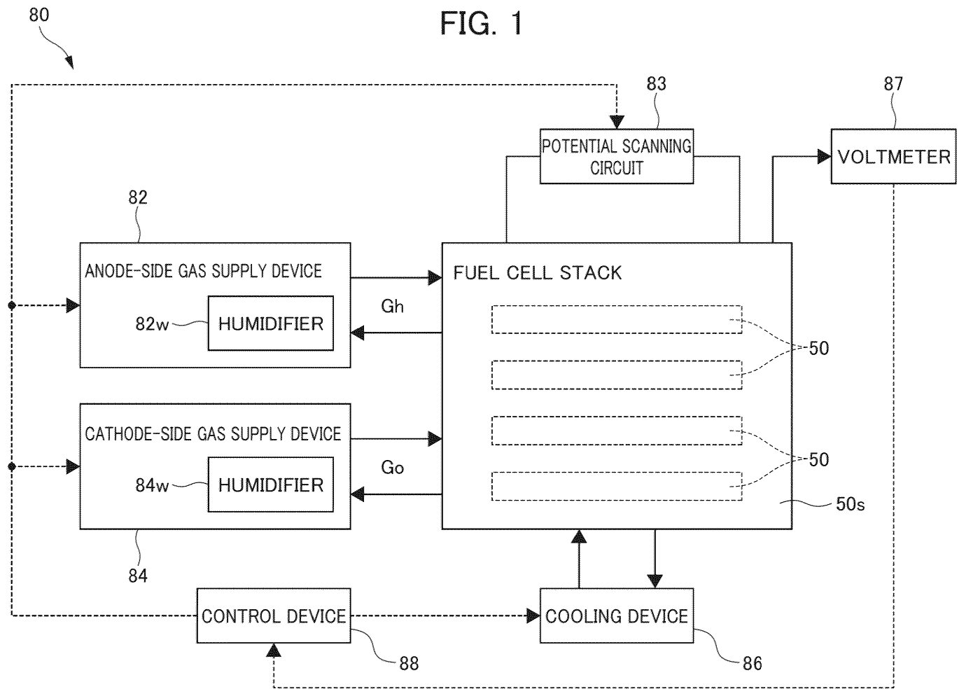

The fuel cell activation apparatus 80 shown in FIG. 1 is installed for a fuel cell stack 50s. A plurality of fuel cells 50 are housed in the fuel cell stack 50s.

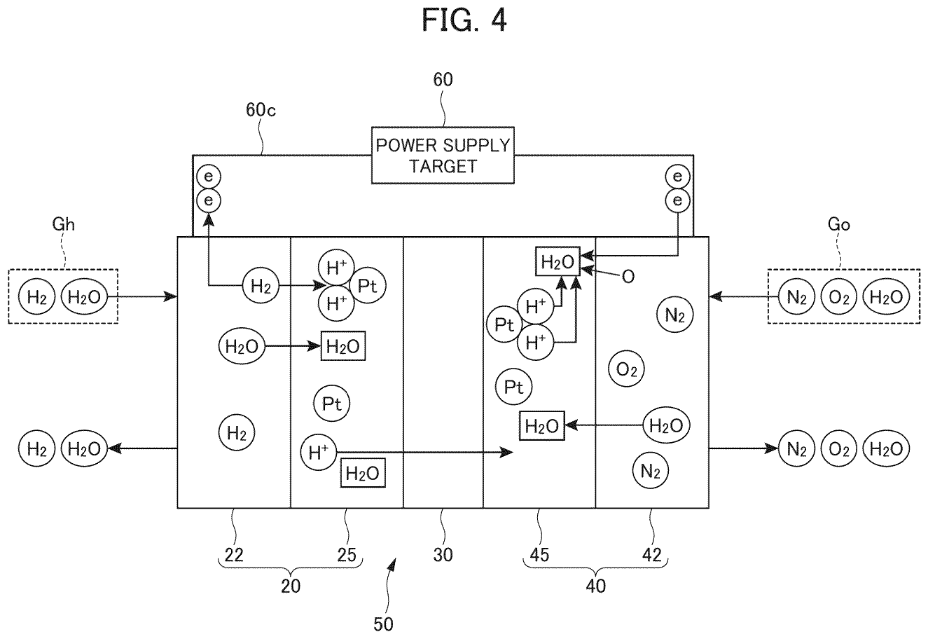

As shown in FIG. 4, each fuel cell 50 includes, in order from one side, an anode layer 20, an electrolyte membrane 30, and a cathode layer 40. The anode layer 20 includes an anode-side gas diffusion layer 22 and an anode-side catalyst layer 25 provided closer to the electrolyte membrane 30 than the anode-side gas diffusion layer 22. The cathode layer 40 includes a cathode-side gas diffusion layer 42 and a cathode-side catalyst layer 45 provided closer to the electrolyte membrane 30 than the cathode-side gas diffusion layer 42. Each of the anode-side gas diffusion layer 22 and the cathode-side gas diffusion layer 42 is mainly composed of a porous layer. The anode-side catalyst layer 25 and the cathode-side catalyst layer 45 contain platinum Pt as a catalyst.

During power generation, the anode layer 20 and the cathode layer 40 are electrically connected to each other via a circuit 60c including a power supply target 60. Hereinafter, the gas containing hydrogen is referred to as “fuel gas Gh”, and the gas containing oxygen is referred to as “oxidizing gas Go”. The oxidizing gas Go is air, and thus contains nitrogen and oxygen. During power generation, the fuel gas Gh is humidified and supplied to the anode-side gas diffusion layer 22, and the oxidizing gas Go is humidified and supplied to the cathode-side gas diffusion layer 42.

From the hydrogen molecules H₂ in the fuel gas Gh in the anode-side gas diffusion layer 22, hydrogen ions H⁺ are dissociated and flow into the anode-side catalyst layer 25, and electrons e are dissociated and flow into the circuit 60c. In this reaction, platinum Pt serves as a catalyst. The hydrogen ions H⁺ flowing into the anode-side catalyst layer 25 pass through the electrolyte membrane 30 and migrate to the cathode-side catalyst layer 45. Hereinafter, such a phenomenon is referred to as “proton pump”. On the other hand, the electrons e flow from the anode layer 20 side toward the cathode layer 40 side in the circuit 60c.

The hydrogen ions H⁺ migrated to the cathode-side catalyst layer 45 are combined with the oxygen atoms O dissociated from the oxygen molecules O₂ in the oxidizing gas Go in the cathode-side gas diffusion layer 42 and the electrons e from the circuit 60c to make water molecules H₂O. The water molecules H₂O diffuse into the cathode-side gas diffusion layer 42. Power generation is performed by the above-described series of flows.

In general, the performance of the fuel cell 50 described above immediately after production is insufficient. The reasons for this include insufficient humidification of the ionomers in the anode-side catalyst layer 25, the electrolyte membrane 30, and the cathode-side catalyst layer 45, and deposits adhering to the platinum Pt. Therefore, it is necessary to activate each fuel cell 50 before shipment of the fuel cell stack 50s shown in FIG. 1. The device for the activation is a fuel cell activation apparatus 80.

As shown in FIG. 1, the fuel cell activation apparatus 80 includes an anode-side gas supply device 82, a cathode-side gas supply device 84, a potential scanning circuit 83, a cooling device 86, a voltmeter 87, and a control device 88. The anode-side gas supply device 82 and the cathode-side gas supply device 84 respectively include humidifiers 82w and 84w that generate water vapor. The control device 88 controls the anode-side gas supply device 82, the cathode-side gas supply device 84, the potential scanning circuit 83, and the cooling device 86.

The voltmeter 87 is configured to be able to measure the output voltage of each fuel cell 50. The output voltage of each fuel cell 50 measured by the voltmeter 87 is inputted to the control device 88.

The cooling device 86 cools each fuel cell 50 by circulating a coolant between the fuel cell stack 50s and a radiator. The control device 88 controls the temperature of each fuel cell 50 to a temperature at which activation easily proceeds by the control of the cooling device 86.

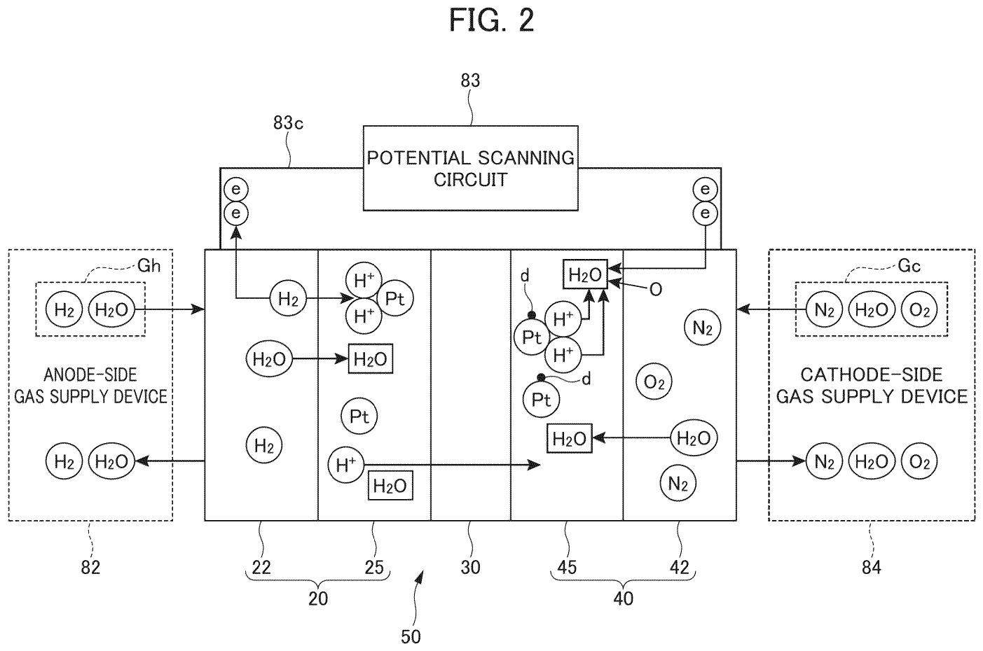

As shown in FIG. 2, the electrode of the anode layer 20 and the electrode of the cathode layer 40 are electrically connected to each other via a circuit 83c including the potential scanning circuit 83. The potential scanning circuit 83 is configured to be able to control the potential of the fuel cell 50. Specifically, the fuel cell 50 applies an external power to activate each fuel cell 50 by controlling the potential of the cathode layer 40 relative to the anode layer 20.

The anode-side gas supply device 82 is configured to be able to supply the fuel gas Gh humidified by the humidifier 82w to the anode-side gas diffusion layer 22. The control device 88 controls the flow rate and pressure of the fuel gas Gh supplied to the anode layer 20 by the control of the anode-side gas supply device 82.

Hereinafter, a gas having an oxygen concentration lower than that of air is referred to as a “low oxygen gas Gc”. The cathode stoichiometric ratio in the low oxygen gas Gc is preferably 1.0 or less. The “cathode stoichiometric ratio” referred to herein is an optimum ratio of the amount of gas supplied to the anode layer 20 relative to the amount of gas supplied to the cathode layer 40.

The cathode-side gas supply device 84 is configured to be able to supply the low oxygen gas by supplying air together with the nitrogen gas N₂, to the cathode-side gas diffusion layer 42. At this time, the low oxygen gas Gc can be humidified by supplying together with the water vapor generated by the humidifier 84w. That is, the cathode-side gas supply device 84 is configured to be able to supply the humidified low oxygen gas Gc to the cathode-side gas diffusion layer 42. The control device 88 controls the flow rate and pressure of the low oxygen gas Gc supplied to the cathode layer 40 by the control of the cathode-side gas supply device 84.

The control device 88 controls the anode-side gas supply device 82 shown in FIG. 2 to humidify the fuel gas Gh and supply the fuel gas Gh to the anode-side gas diffusion layer 22, controls the cathode-side gas supply device 84 to humidify the low oxygen gas Gc and supply the low oxygen gas Gc to the cathode-side gas diffusion layer 42, and controls the cathode potential by the potential scanning circuit 83. With such a configuration, a proton pump is generated.

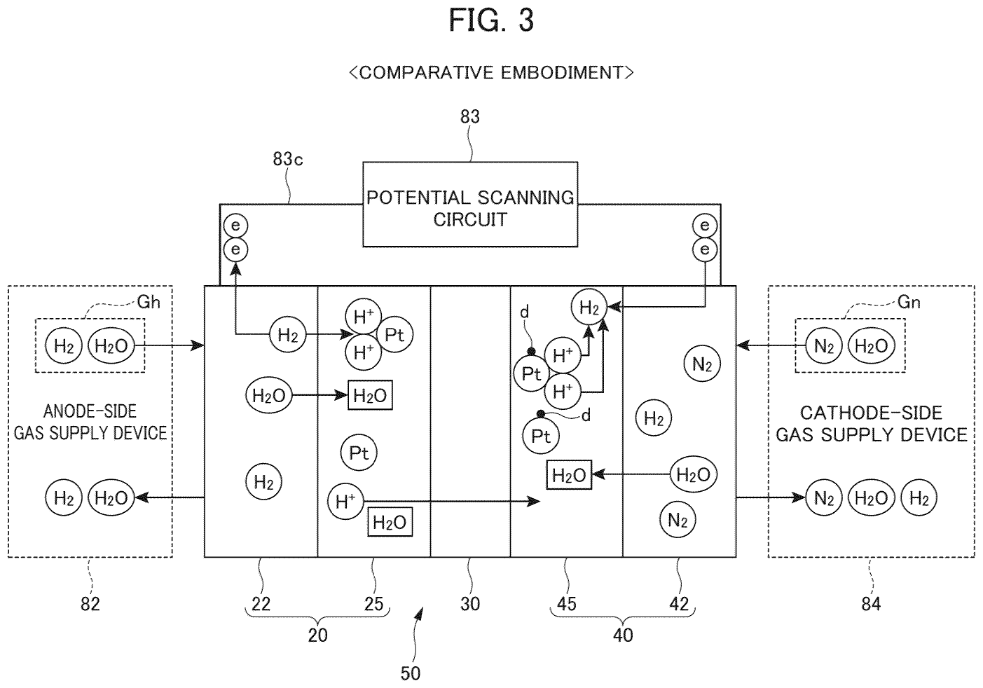

Hereinafter, as shown in FIG. 3, a mode in which the cathode-side gas supply device 84 supplies not the low oxygen gas Gc but rather the nitrogen gas Gn to the cathode-side gas diffusion layer 42 during the proton pumping is referred to as a comparative embodiment. That is, in this comparative embodiment, the fuel cell 50 is activated by the non-power generation method.

In this comparative embodiment, from the hydrogen molecules H₂ in the fuel gas Gh in the anode-side gas diffusion layer 22, the hydrogen ions H⁺ are dissociated and flow into the anode-side catalyst layer 25, and the electrons e are dissociated and flow into the circuit 83c. In this reaction, platinum Pt serves as a catalyst. The hydrogen ions H⁺ flowing into the anode-side catalyst layer 25 pass through the electrolyte membrane 30 and migrate to the cathode-side catalyst layer 45. On the other hand, the electrons e flow from the anode layer 20 side toward the cathode layer 40 side in the circuit 83c.

The hydrogen ions H⁺ migrated to the cathode-side catalyst layer 45 are combined with the electrons e from the circuit 83c to become hydrogen molecules H₂. The hydrogen molecules H₂ diffuse into the cathode-side gas diffusion layer 42. Due to the flow of ions accompanying the proton pump, moisture H₂O migrates to humidify the fuel cell 50.

However, unlike the power generation method, since the water molecules H₂O are not generated from the hydrogen ions H⁺ in the cathode layer 40, deposits d on the platinum Pt are not washed away by the generated water molecules H₂O. In addition, the ionomers of the cathode-side gas diffusion layer 42 are not humidified by the generated water molecules H₂O. Therefore, the activation effect of the fuel cell 50 is lower than that of the power generation method.

In this regard, in the present embodiment shown in FIG. 2, at the time of proton pump, the cathode-side gas supply device 84 supplies the low oxygen gas Gc rather than the nitrogen gas Gn to the cathode-side gas diffusion layer 42.

Also in the present embodiment, from the hydrogen molecules H₂ in the fuel gas Gh in the anode-side gas diffusion layer 22, the hydrogen ions H⁺ are dissociated and flow into the anode-side catalyst layer 25, and the electrons e are dissociated and flow into the circuit 83c. The hydrogen ions H⁺ flowing into the anode-side catalyst layer 25 pass through the electrolyte membrane 30 and migrate to the cathode-side catalyst layer 45. On the other hand, the electrons e flow from the anode layer 20 side toward the cathode layer 40 side in the circuit 83c. The processing up to this point is the same as that in the above-described comparative embodiment.

The hydrogen ions H⁺ migrated to the cathode-side catalyst layer 45 are combined with the oxygen atoms O dissociated from the oxygen molecules O₂ in the low oxygen gas Gc in the cathode-side gas diffusion layer 42 and the electrons e from the circuit 60c to make water molecules H₂O. The deposits d attached to the platinum Pt are washed away by the water H₂O. As a result, the effective catalyst surface area of platinum Pt increases, and the fuel cell 50 is activated.

Further, in the present embodiment, since the water molecules H₂O are generated in the cathode layer 40, the ionomers of the cathode-side catalyst layer 45 are more easily humidified, and the fuel cell 50 is more easily activated.

The configuration and advantageous effects of the present embodiment will be summarized below.

According to the present embodiment, as shown in FIG. 2, the proton pump is generated by supplying the fuel gas Gh to the anode layer 20, and controlling the potential of the cathode layer 40. The hydrogen ions H⁺ migrated to the cathode layer 40 by the proton pump combine with the oxygen O₂ in the low oxygen gas Gc to generate water H₂O. The water H₂O washes the deposits adhering to the platinum Pt in the cathode layer 40. In addition, the fuel cell 50 is humidified by the generated water H₂O. This makes it possible to achieve a higher activation effect than in the comparative embodiment in which the non-power generation method is performed.

At this time, since the low oxygen gas Gc is supplied to the cathode layer 40, the stoichiometric ratio becomes lower than that in the case where air is supplied. By lowering the stoichiometric ratio in this way, it is possible to suppress the supply amount of the fuel gas Gh, and it is possible to suppress the output of the fuel cell 50. As a result, it is possible to reduce the size of the main body of the fuel cell activation apparatus 80, and it is possible to reduce the cost as compared with the case where air is supplied to the cathode layer 40, that is, as compared with the power generation method.

As described above, according to the present embodiment, it is possible to realize a higher activation effect than that of the non-power generation method at a cost lower than that of the power generation method.

Further, it is possible for the cathode-side gas supply device 84 to supply the low oxygen gas Gc to the cathode layer 40 easily and inexpensively by supplying air and nitrogen N₂ to the cathode layer 40.

### Other Embodiments

The embodiment described above can be modified as follows, for example. The potential scanning circuit 83 shown in FIG. 2 may be configured to be able to apply a negative voltage to the cathode layer 40 with respect to the anode potential. Then, the control device 88 may make the potential of the cathode layer 40 negative by the potential scanning circuit 83 at the time of proton pump. In this case, the platinum Pt of the anode layer 20 and the cathode layer 40 is easily negatively charged. Therefore, a repulsive force is likely to be generated between the platinum Pt and the deposits d. This is because the deposits d adhering to the platinum Pt are often negatively charged. As a result, the deposits d easily float from the platinum Pt, and the deposits d is more easily washed away from the platinum Pt.

### EXPLANATION OF REFERENCE NUMERALS

20 Anode Layer
30 Electrolyte Membrane
40 Cathode Layer
50 Fuel Cell
80 Fuel Cell Activation Apparatus
82 Anode-side Gas Supply Device
83 Voltage Scanning Circuit
84 Cathode-side Gas Supply Device
Gh Fuel Gas
Gc Low Oxygen Gas
Pt Platinum

What is claimed is:

1. A fuel cell activation apparatus that activates a fuel cell, the fuel cell including, in order from one side, an anode layer, an electrolyte membrane, and a cathode layer, the anode layer and the cathode layer including platinum as a catalyst, the fuel cell activation apparatus comprising:
an anode-side gas supply device that is configured to supply a fuel gas as a gas including hydrogen to the anode layer;
a cathode-side gas supply device that is configured to supply a low oxygen gas as a gas having an oxygen concentration lower than that of air to the cathode layer; and
a potential scanning circuit that is configured to control a potential of the fuel cell,
wherein the anode-side gas supply device supplies the fuel gas to the anode layer, the cathode-side gas supply device supplies the low oxygen gas to the cathode layer, and the potential scanning circuit controls the potential of the cathode layer, such that the fuel cell is activated.

2. The fuel cell activation apparatus according to claim 1, wherein the cathode-side gas supply device supplies air and nitrogen to the cathode layer to supply the low oxygen gas to the cathode layer.
